(19) United States
(12) Patent Application Publication
(10) Pub. No.: US 2020/0319753 A1
(43) Pub. Date: Oct. 8, 2020

(54) TOUCH PANEL AND ELECTRONIC DEVICE INCLUDING SAME

(71) Applicant: HON HAI PRECISION INDUSTRY CO., LTD., New Taipei (TW)

(72) Inventors: REN-YI HUANG, New Taipei (TW); YUAN-HUNG CHIEN, New Taipei (TW)

(21) Appl. No.: 16/412,855

(22) Filed: May 15, 2019

(30) Foreign Application Priority Data
Apr. 3, 2019 (CN) 201910265704.4

(51) Int. Cl. G06F 3/044; G06F 3/01

(52) U.S. Cl. CPC G06F 3/0447; G06F 3/0448; G06F 3/016

(57) ABSTRACT

A touch panel includes a plurality of touch electrodes, a force sensing electrode, a processor, and a vibration structure. The touch electrodes acquire a touch signal generated by a touch operation in real time. The force sensing electrode is disposed opposite to the touch electrodes and forms a capacitor structure with the touch electrodes. The capacitor structure includes an initial capacitance. The processor is electrically coupled to the touch electrodes and the force sensing electrode and detects a position of the touch operation according to a capacitance difference effected by the touch operation and generates a control signal according to the capacitance difference. The vibration structure is electrically coupled to the processor and vibrates in response to the control signal.

### FIELD

The subject matter herein generally relates to touch panels, and more particularly to a touch panel of an electronic device.

### BACKGROUND

Capacitive touch panels are widely used in electronic devices. In the related art, the capacitive touch panel detects a position of a touch operation on a surface of the touch panel, and calculates a position of the touch operation according to a change in capacitance. However, the touch panel structure can only implement basic touch functions, so an improved touch feedback experience is desired.

### BRIEF DESCRIPTION OF THE DRAWINGS

Implementations of the present disclosure will now be described, by way of embodiments, with reference to the attached figures.

FIG. 1 is an isometric view of an embodiment of an electronic device.

FIG. 2 is a cross-sectional view of a first embodiment of a touch panel taken along line II-II in FIG. 1.

FIG. 3 is a diagrammatic view of a first touch electrode group, a second touch electrode group, and a force sensing electrode.

FIG. 4 is a diagrammatic view of a first touch electrode group, a second touch electrode group, and a force sensing electrode according to another embodiment.

FIG. 5 is a cross-sectional view of a second embodiment of a touch panel taken along line II-II in FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

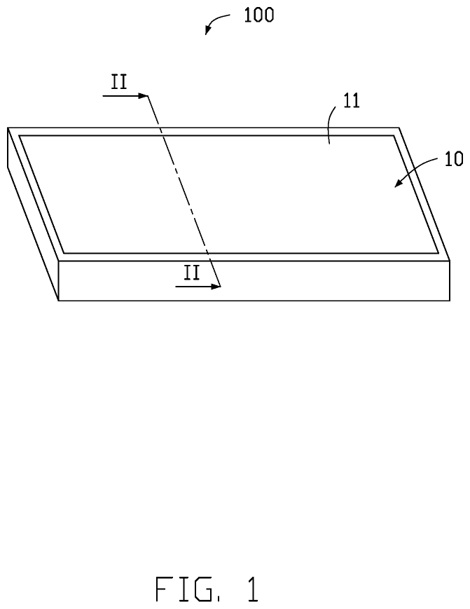

FIG. 1 shows a first embodiment of an electronic device 100 including a touch panel 10. The electronic device 100 in the embodiment can be an electronic device having touch functions, such as a touch display device, a mobile terminal, a smart home appliance, and the like. In this embodiment, the electronic device 100 is a touch display device.

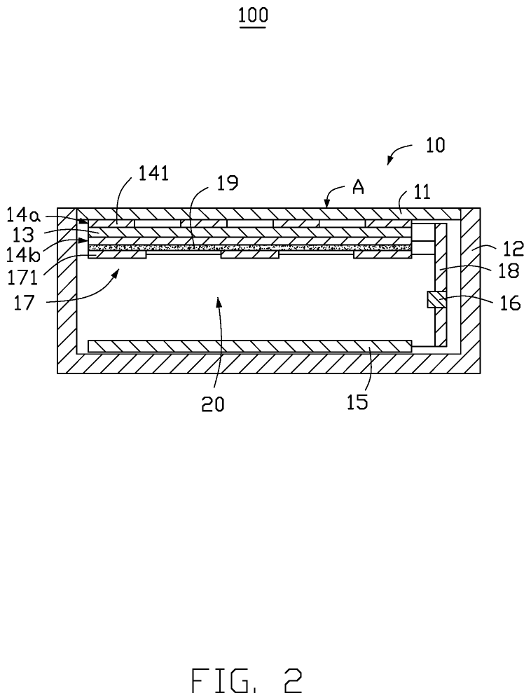

Referring to FIG. 2, the touch panel 10 includes a cover 11 and an outer frame 12. The cover 11 and the outer frame 12 enclose and cooperatively define a closed receiving space 20. The cover 11 includes a surface A facing away from the receiving space 20. The surface A is used as a touch surface for receiving touch operations of a user.

Referring to FIG. 2, the touch panel 10 further includes a base plate 13 received in the receiving space 20, a plurality of touch electrodes 141 disposed on the base plate 13, a force sensing electrode 15 disposed opposite to the plurality of touch electrodes 141, a processor 16 electrically coupled to the touch electrodes 141 and the force sensing electrode 15, and a vibration structure 17 electrically coupled to the processor 16.

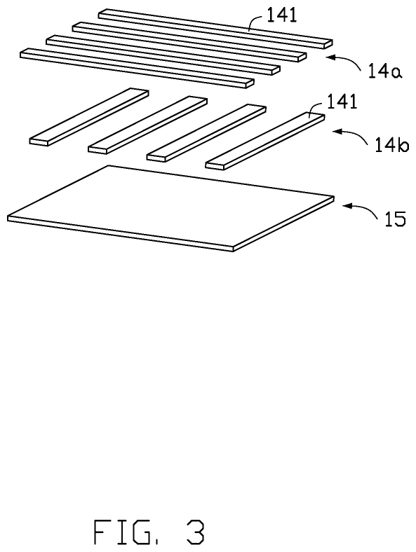

Referring to FIG. 2 and FIG. 3, the plurality of touch electrodes 141 are divided into a first touch electrode group 14a and a second touch electrode group 14b. The first touch electrode group 14a and the second touch electrode group 14b each include a plurality of touch electrodes 141. The first touch electrode group 14a is disposed on a side of the base plate 13 facing the cover 11, and the second touch electrode group 14b is disposed on a side of the base plate 13 facing away from the cover 11. Each of the touch electrodes 141 is elongated. The touch electrodes 141 of the first touch electrode group 14a are spaced apart and arranged in parallel along a first direction, and the touch electrodes 141 of the second touch electrode group 14b are spaced apart and arranged in parallel along a second direction perpendicular to the first direction. One of the first touch electrode group 14a and the second touch electrode group 14b serves as a touch scanning electrode group, and the other is used as a touch sensing electrode group to jointly acquire a touch signal generated by a touch operation in real time. The touch signal is used to calculate a position of the touch operation on the cover 11 in real time.

In other embodiments, the first touch electrode group 14a and the second touch electrode group 14b may be insulatedly disposed on a same surface of the base plate 13. In other embodiments, the touch electrodes 141 may be diamond-shaped electrodes, metal mesh electrodes, or the like.

The force sensing electrode 15 is located on a side of the second touch electrode group 14b away from the first touch electrode group 14a and is spaced apart from the second touch electrode group 14b. In one embodiment, the force sensing electrode 15 is a continuous conductive layer and has a surface area corresponding to a surface area of the second touch electrode group 14b. The force sensing electrode 15 and the second touch electrode group 14b form a capacitor structure. When there is no touch operation applied, an initial capacitance of the capacitor structure is expressed as C0. Specifically, the force sensing electrode 15 forms a capacitor structure with each of the touch electrodes 141 of the second touch electrode group 14b, and each capacitor structure has an initial capacitance of C0.

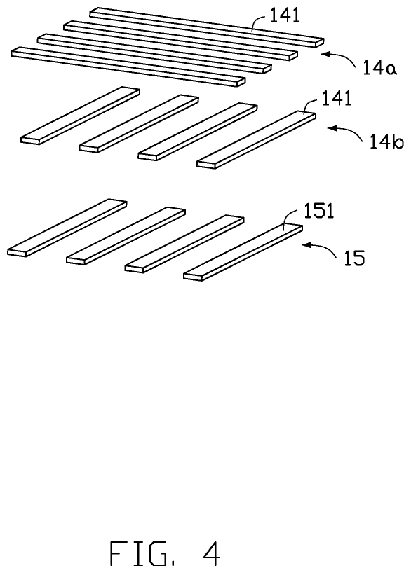

Referring to FIG. 4, in another embodiment, the force sensing electrode 15 may also include a plurality of force sensing electrodes 151 that are spaced apart from each other and electrically coupled to each other, wherein the force sensing electrodes 151 and the touch electrodes 141 of the second touch electrode group 14b are disposed in a corresponding one-to-one relationship. That is, an extending direction of each of the force sensing electrodes 151 is substantially the same as an extending direction of each of the touch electrodes 141 of the second touch electrode group 14b, and a capacitor structure having an initial capacitance of C0 is formed between the force sensing electrodes 151 and respective touch electrodes 141 of the second touch electrode group 14b. In another embodiment, the extending direction of each of the force sensing electrodes 151 may be substantially perpendicular to the extending direction of the touch electrodes 141 of the second touch electrode group 14b, as long as a capacitor structure having an initial capacitance of C0 is formed at each intersection of the force sensing electrodes 151 and the touch electrodes 141 of the second touch electrode group 14b.

Referring again to FIG. 2, the touch panel 10 further includes a circuit board 18. The processor 16 is a control chip disposed on the circuit board 18, and each of the touch electrodes 141 and the force sensing electrode 15 are coupled to the processor 16.

The vibration structure 17 is adhered to a side of the second touch electrode group 14b facing away from the base plate 13 through an adhesive layer 19. The vibration structure 17 includes a plurality of spaced apart and electrically coupled vibration blocks 171, which may be vibration motors. The vibration structure 17 is electrically coupled to the processor 16 and configured to vibrate in response to control signals output by the processor 16.

The following describes a working process of the touch panel 10 described above:

The touch panel 10 is a capacitive touch panel. The first touch electrode group 14a is a touch driving electrode group, and the second touch electrode group 14b is a touch sensing electrode group. In other embodiments, the second touch electrode group 14b can be a touch driving electrode group, and the first touch electrode group 14a can be a touch sensing electrode group.

When a touch operation such as a finger touch occurs on the cover 11, the processor 16 outputs a touch driving signal to the first touch electrode group 14a, and receives a touch sensing signal generated by the second touch electrode group 14b according to the touch driving signal. The processor 16 calculates a position of the touch operation according to the touch sensing signal.

At the same time, when the touch operation occurs, the touch panel 10 is pressed at the position where the touch operation occurs, and the second touch electrode group 14b corresponding to the position where the touch operation occurs is displaced toward the force sensing electrode 15. The initial capacitance C0 between the force sensing electrode 15 and the second touch electrode group 14b is changed, and a detection capacitance C1 is defined as C1=C0+AC, wherein AC is a capacitance difference from the initial capacitance C0. The processor 16 prestores a change threshold Cm. The processor 16 detects the detected capacitance value C1 and determines whether the capacitance difference AC is greater than the change threshold Cm. If the capacitance difference AC is greater than the change threshold Cm, the processor 16 generates a control signal, and the control signal is output to the vibration block 171 corresponding in position to where the touch operation occurs, and the vibration block is controlled to vibrate. Thus, careless smaller touches on the touch panel 10 are prevented from being regarded as a touch operation, and the vibration structure 17 is prevented from erroneously vibrating, which is beneficial to reducing energy consumption of the touch panel 10.

In another embodiment, the vibration structure 17 is a continuous structure including only one vibration block 171 corresponding in size to the entire touch panel 10. When the processor 16 outputs the control signal to control the vibration of the vibration structure 17, the entire touch panel 10 is vibrated.

The touch panel 10 can provide a feedback signal (vibration) when a touch operation is applied on the touch panel 10, which is beneficial to improving a user's touch feedback experience. The vibration structure 17 includes a plurality of spaced apart vibration blocks 171, and the control signal output by the processor 16 controls only the vibration block 171 corresponding in position to where the touch operation occurs to vibrate. Thus, localized vibration can be realized, which is beneficial to saving energy consumption and improving a user's touch feedback experience.

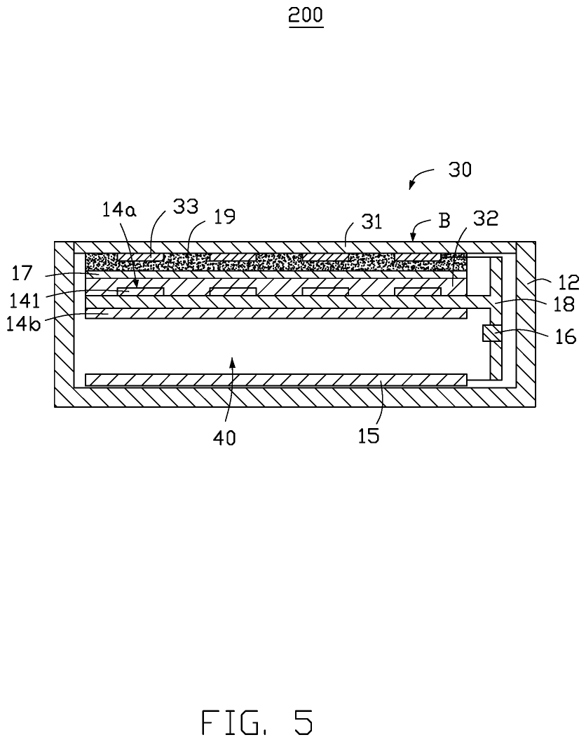

FIG. 5 shows a second embodiment of an electronic device 200 including a touch panel 30. A difference between the electronic device 200 and the electronic device 100 is that placement positions of the vibration structure 17 and the circuit board 18 are different.

Specifically, a cover 31 and the outer frame 12 enclose and cooperatively define a closed receiving space 40. The cover 31 includes a surface B facing away from the receiving space 40. The surface B is used to receive a touch operation of a user.

The touch panel 30 further includes a circuit board 18 disposed in the receiving space 40, a first touch electrode group 14a disposed on a side of the circuit board 18 facing the cover 31, a second touch electrode group 14b disposed on a side of the circuit board 18 facing away from the cover 31, a force sensing electrode 15 disposed opposite to the second touch electrode group 14b, a processor 16 electrically coupled to the touch electrodes 141 and the force sensing electrode 15, and a vibration structure 17 disposed between the cover 31 and the first touch electrode group 14a and electrically coupled to the processor 16. The touch panel 30 further includes an insulation layer 32 disposed between the cover 31 and the first touch electrode group 14a. The vibration structure 17 is embedded in the insulation layer 32.

In the embodiment, the touch panel 30 further includes a fingerprint detection structure 33 disposed between the cover 31 and the vibration structure 17. Specifically, the fingerprint detection structure 33 includes a plurality of photodiodes, which are adhered to the cover 31 through an adhesive layer 19. The photodiodes are electrically coupled to the processor 16 through a trace (not shown). When a touch operation occurs (finger touch), the photodiode emits a first light to the touch panel 30, and a second light is reflected from the touch panel 30. The second light is converted into point signals, and then according to differences in the point signals by ridges of a finger reflecting the second light, a fingerprint image can be generated to identify a fingerprint. Therefore, as described above, the touch panel 30 can implement a fingerprint recognition function.

It should be understood that the touch panel 30 can achieve all the beneficial effects as described in the first embodiment. Since the vibration structure 17 in the second embodiment is closer to the cover 31, when a touch operation occurs, a vibration is stronger, which further improves the touch feedback experience. The touch panel 30 provided in this embodiment is further capable of implementing a fingerprint recognition function.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A touch panel comprising:
a plurality of touch electrodes for acquiring a touch signal generated by a touch operation in real time;
a force sensing electrode disposed opposite to the plurality of touch electrodes, the force sensing electrode forming a capacitor structure with the plurality of touch electrodes, the capacitor structure comprising an initial capacitance, a capacitance difference effected by the touch operation;
a processor electrically coupled to the plurality of touch electrodes and the force sensing electrode and configured to detect a position of the touch operation and generate a control signal according to the capacitance difference; and
a vibration structure electrically coupled to the processor and configured to vibrate in response to the control signal.

2. The touch panel of claim 1, wherein:
the vibration structure comprises a plurality of spaced apart vibration blocks;
the processor generates the control signal and sends the control signal to the vibration block corresponding in position to the touch operation to vibrate.

3. The touch panel of claim 1, wherein:
the processor is configured to determine whether the capacitance difference is greater than a prestored change threshold;
when the processor determines that the capacitance difference is greater than the change threshold, the processor generates the control signal to control the vibration structure to vibrate.

4. The touch panel of claim 1, wherein:
the force sensing electrode is a continuous conductive layer.

5. The touch panel of claim 1, wherein:
the plurality of touch electrodes form a first touch electrode group and a second touch electrode group;
the first electrode group and the second electrode group are oppositely disposed and cooperatively acquire the touch signal of the touch operation in real time;
the force sensing electrode is disposed on a side of the second electrode group facing away from the first electrode group;
the force sensing electrode is disposed opposite to the second electrode group and forms a capacitor structure having the initial capacitance with the second electrode group.

6. The touch panel of claim 5, wherein:
the force sensing electrode comprises a plurality of electrically coupled force sensing electrodes;
the force sensing electrodes and the touch electrodes of the second touch electrode group are disposed in a corresponding one-to-one relationship.

7. The touch panel of claim 5, further comprising a base plate and a cover, wherein:
the first touch electrode group is disposed on a side of the base plate facing the cover;
the second touch electrode group is disposed on a side of the base plate facing away from the cover;
the vibration structure is adhered to a side of the second touch electrode group facing away from the base plate.

8. The touch panel of claim 5, further comprising a circuit board and a cover, wherein:
the first touch electrode group is disposed on a side of the circuit board facing the cover;
the second touch electrode group is disposed on a side of the circuit board facing away from the cover;
the vibration structure is disposed between the cover and the first touch electrode group.

9. The touch panel of claim 8, further comprising a fingerprint detection structure disposed between the cover and the vibration structure.

10. An electronic device comprising a touch panel comprising:
a plurality of touch electrodes for acquiring a touch signal generated by a touch operation in real time;
a force sensing electrode disposed opposite to the plurality of touch electrodes, the force sensing electrode forming a capacitor structure with the plurality of touch electrodes, the capacitor structure comprising an initial capacitance, a capacitance difference effected by the touch operation;
a processor electrically coupled to the plurality of touch electrodes and the force sensing electrode and configured to detect a position of the touch operation and generate a control signal according to the capacitance difference; and
a vibration structure electrically coupled to the processor and configured to vibrate in response to the control signal.

11. The electronic device of claim 10, wherein:
the vibration structure comprises a plurality of spaced apart vibration blocks;
the processor generates the control signal and sends the control signal to the vibration block corresponding in position to the touch operation to vibrate.

12. The electronic device of claim 10, wherein:
the processor is configured to determine whether the capacitance difference is greater than a prestored change threshold;
when the processor determines that the capacitance difference is greater than the change threshold, the processor generates the control signal to control the vibration structure to vibrate.

13. The electronic device of claim 10, wherein:
the force sensing electrode is a continuous conductive layer.

14. The electronic device of claim 10, wherein:
the plurality of touch electrodes form a first touch electrode group and a second touch electrode group;
the first electrode group and the second electrode group are oppositely disposed and cooperatively acquire the touch signal of the touch operation in real time;
the force sensing electrode is disposed on a side of the second electrode group facing away from the first electrode group;
the force sensing electrode is disposed opposite to the second electrode group and forms a capacitor structure having the initial capacitance with the second electrode group.

15. The electronic device of claim 14, wherein:
the force sensing electrode comprises a plurality of electrically coupled force sensing electrodes;
the force sensing electrodes and the touch electrodes of the second touch electrode group are disposed in a corresponding one-to-one relationship.

16. The electronic device of claim 14 further comprising a base plate and a cover, wherein:
the first touch electrode group is disposed on a side of the base plate facing the cover;
the second touch electrode group is disposed on a side of the base plate facing away from the cover;
the vibration structure is adhered to a side of the second touch electrode group facing away from the base plate.

17. The electronic device of claim 14 further comprising a circuit board and a cover, wherein:
the first touch electrode group is disposed on a side of the circuit board facing the cover;
the second touch electrode group is disposed on a side of the circuit board facing away from the cover;
the vibration structure is disposed between the cover and the first touch electrode group.

18. The electronic device of claim 17 further comprising a fingerprint detection structure disposed between the cover and the vibration structure.
